(19) United States
(12) Patent Application Publication
(10) Pub. No.: US 2009/0308226 A1
(43) Pub. Date: Dec. 17, 2009

(54) Expandable drum

(76) Inventor: James J. Paterson, Toronto (CA)

Correspondence Address: GEORGE A. ROLSTON, 45 SHEPPARD AVE EAST, SUITE 900, TORONTO, ON, M2N5W9, CA

(21) Appl. No.: 12/457,232

(22) Filed: Jun. 4, 2009

Related U.S. Application Data
(60) Provisional application No. 61/131,861, filed on Jun. 13, 2008.

(51) Int. Cl. G10D 13/02

(52) U.S. Cl. 84/412

(57) ABSTRACT

An interchangeable drum assembly having a first drum body member, a first drum skin, a first drum skin tension device secured to said first drum body member, a second drum body member, a second drum skin, first tension members on the first drum body, second tension members on the second drum body, and, drum body connector rods extending between the first and second drum bodies by which the first and second drum bodies are attached to one another in edge abutting relation, and a drum body extension which can be releasably positioned between the first and second drum body members, to make the drum body deeper.

### FIELD OF THE INVENTION

This application claims priority of the filing date of U.S. Provisional application Ser. No. 61/131,861 filed Jun. 13 2008, Title EXPANDRUM SYSTEM.

The invention relates to drums, and in particular to a drum apparatus in which the drum body can be interchanged and made longer or shorter to change the size of the drum.

### BACKGROUND OF THE INVENTION

Drums conventionally employ a cylindrical drum body defining a hollow chamber, and a drum skin, on one, or both ends of the body. The drum skins are mounted in hoops which supports the skins. Tensioning devices are attached to the exterior of the body, and to the hoops. By adjusting the tensioning devices, the drum skins can be made tighter or looser.

Usually there are drum skins and hoops and tensioning devices at both ends of the body.

All of this has been well known. Drums will have different sounds depending on the depth of the drum body. A drummer may require a drum with a body of one size for one type of performance and may require a drum with a body of a different size for another performance. This would require an investment in two or more drums of different sizes. The drummer will have the inconvenience of carrying several drums of different sizes, if they are required for an occasion.

Various proposals have been made to provide a drum with an extension for the body. The intent has been that the drummer can modify the drum by increasing or decreasing the depth of the drum body.

However, the proposals that have been made in the past have been somewhat cumbersome and complex. The construction of a drum requires tensioning devices, located at spaced points around the circumference of the drum skin(s), These devices must be attached to the drum body, so that the skin(s) can be tensioned equally around the drum body. Where there are both top and bottom drum skins, it may be desirable to tension one skin at a tension different from the other. For this reason separate top and bottom tension devices are provided.

These features are provided with conventional drums, by attaching the tensioning devices to the drum body. The tensioning devices connect to each drum skin ring by means of tension rods, in this type of drum. It is found that the tension rods should be kept out of contact with the drum body, since any contact may impair the sound of the drum.

Where it has been proposed in the past to attempt to provide a drum with a drum body which can be extended, these features have been a compromise. Clearly it would be necessary to attach and secure the various parts of the drum body together. However, the components for such attachment should be free of contact with the drum body as far as possible, for the reasons explained above.

### BRIEF SUMMARY OF THE INVENTION

The invention therefor seeks to provide an interchangeable drum assembly comprising, a first drum body member, a first drum skin, first drum skin tension device secured to said first drum body member, a second drum body member, a second drum skin, a first tension members secured to said first drum body;

second tension members secured to said second drum body, and,

drum body connector rods extending between some of said first and second tension members whereby said first drum body and said second drum body are attached to one another in edge abutting relation.

Preferably there will be first drum skin tension rods connecting with a first drum skin hoop, and second drum skin tension rods connecting with a second drum skin hoop.

Preferably the connector rods will be received in respective first tension members and second tension members

Preferably the connecting rods will be releasable to permit the first drum body and second drum body to be separated from one another.

Preferably there will be a drum body extension which can be placed between the first drum body and the second drum body, and longer connector rods will extend between the first tension member and the second tension member holding the first drum body and second drum body and the drum body extension together.

Preferably the first tension member and the second tension member will have extension portions overlapping the drum body extension and holding it in alignment with the first drum body and the second drum body.

Preferably the first tension member and second tension member will be secured to their respective first drum body and second drum body by bolts passing from the interior of the first drum body and second drum body into the first tension member and second tension member.

Preferably the first tension member and the second tension member will comprise an inner box portion and an outer box portion interfitting with one another, with the bolts passing from the first drum body and second drum body through the inner box portion and secured in the outer box portion.

In an alternate embodiment, an extension kit for an existing drum can be provided in which a plurality of connector blocks are attachable to the tension members on respective drum body halves, and connector rods extend between the connector blocks.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a perspective of a interchangeable drum illustrating the invention;

FIG. 2 is a section along line 2-2 of FIG. 1;

FIG. 3 is a side elevation of the drum of FIGS. 1 and 2 showing an extension portion in position;

FIG. 4 is an exploded perspective of FIG. 3 and showing an extension portion, and connecting rods;

FIG. 5 is an enlarged side elevation of a detail of FIG. 3;

FIG. 6 is an exploded perspective of a tension member from one direction;

FIG. 7 is an exploded perspective of the tension member from another direction; and.

FIG. 8 is a perspective of an alternate embodiment, providing an extension kit for changing the size of an existing drum.

### DESCRIPTION OF A SPECIFIC EMBODIMENT

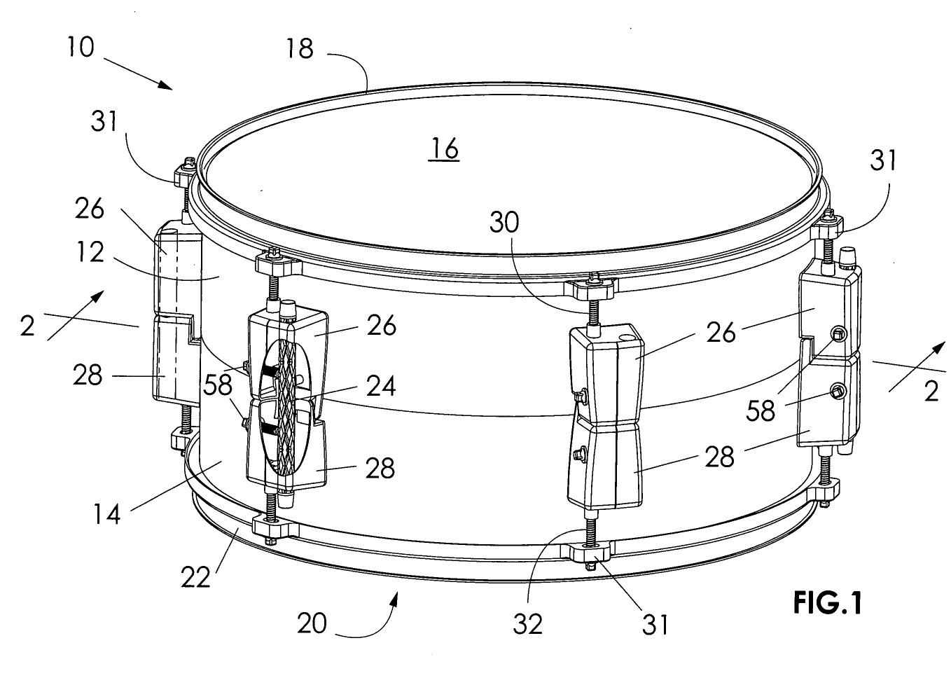

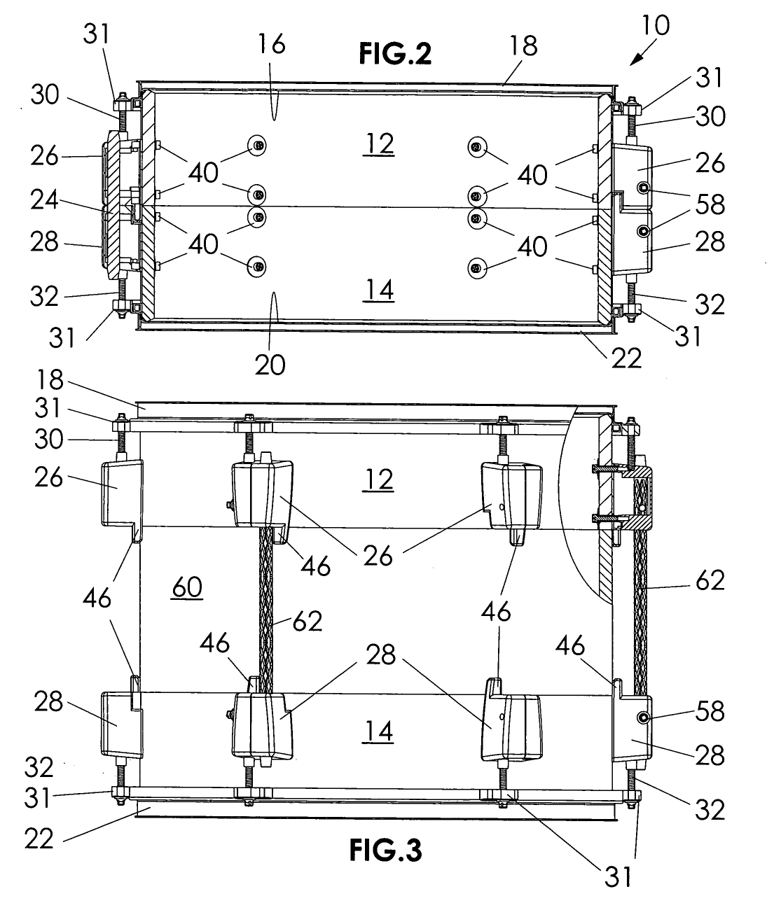

As shown in FIGS. 1 and 2 the invention is illustrated here in the form of a drum (10) The drum (10) has a first drum body member (12) and an second drum body member (14), each of cylindrical construction and of identical diameter and wall thickness, and in this case of the same material, though other materials may be used if desired. The two drum bodies abut each other at their adjoining edges to form a single body for drum (10). First drum body member (12) has a first drum skin (16) and a first drum skin hoop (18). Second drum body member (14) has a second drum skin (20) and a second drum skin hoop (22).

The first drum body member and second drum body member are held together in a manner described below by drum body connecting rods (24)

The first drum body member (12) has first tension members (26) attached at spaced locations around its circumference by suitable bolts.

Second drum body member (14) has second tension members (28) attached at spaced locations around its circumference.

The first drum skin hoop (18) is connected to the first tension members (26) by first tension rods (30) and lugs (31).

The second drum skin hoop (22) is connected to the second tension members (28) by second tension rods (32) and lugs (31).

In this way the respective first drum skin (16) and second drum skin (20) can be tensioned over the ends of the respective first drum body member (12) and second drum body member (14), but are independent of each other.

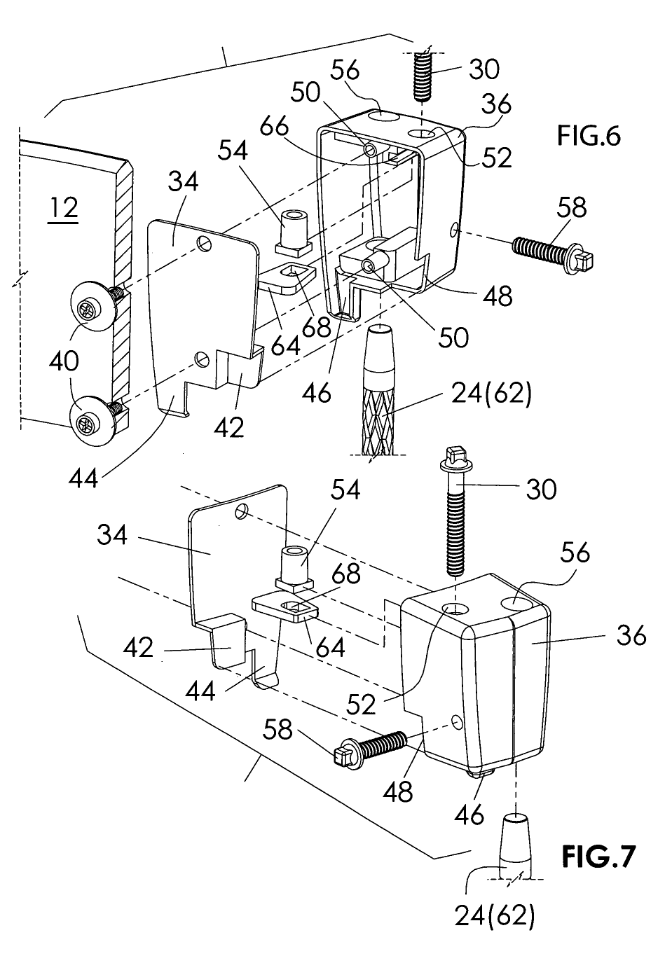

The first tension member (26) and the second tension member (28) are formed as shown in FIGS. 6 and 7.

They each comprise a hollow box-like enclosure or chamber formed by an inner gasket portion (34) and an outer box portion (36), which are formed with complementary shapes to interfit together and form a hollow box or chamber.

The inner gasket portion (34) has bolt holes (38) for passage of bolts (40) from the interiors of the respective first drum body member and second drum body member.

The inner gasket portion (34) has an inwardly angled indent (42), on one side, and has an extension lip (44) on the other side, for reasons to be described below.

The outer box portion (36) has an elongated shell (46), extending therefrom in registration with the extension lip (44) of the inner gasket portion (34), for reasons to be described below.

The outer box portion (36) has a cut away wall (48), complementary to the inward angled indent (42) of the inner gasket portion (34) for reasons to be described below.

The outer box portion (36) has threaded recesses (50) for receiving bolts (40) and thus securing the inner gasket portion and the outer box portion to the exterior of the first drum body member, or second drum body member, respectively.

The outer box portions (36) have tension rod openings (52) for receiving the respective first tension rod (30) and second tension rod (32). Socket nuts (54) are located inside outer box portion (36) for receiving the first tension rod or second tension rod respectively.

The outer box portion has two connector rod openings (56) for receiving the drum body connector rods(24). Transverse bolts or set screws (58) can be torqued onto drum body connector rods(24) to hold the first drum body member and second drum body member secured together.

The drum body connector rods(24) in this case may have any suitable frictional surface formations such as knurling. Alternatively the rods may be threaded, and nuts could be used on threaded rods to hold the drum bodies assembled. In this case the set screws could be dispensed with.

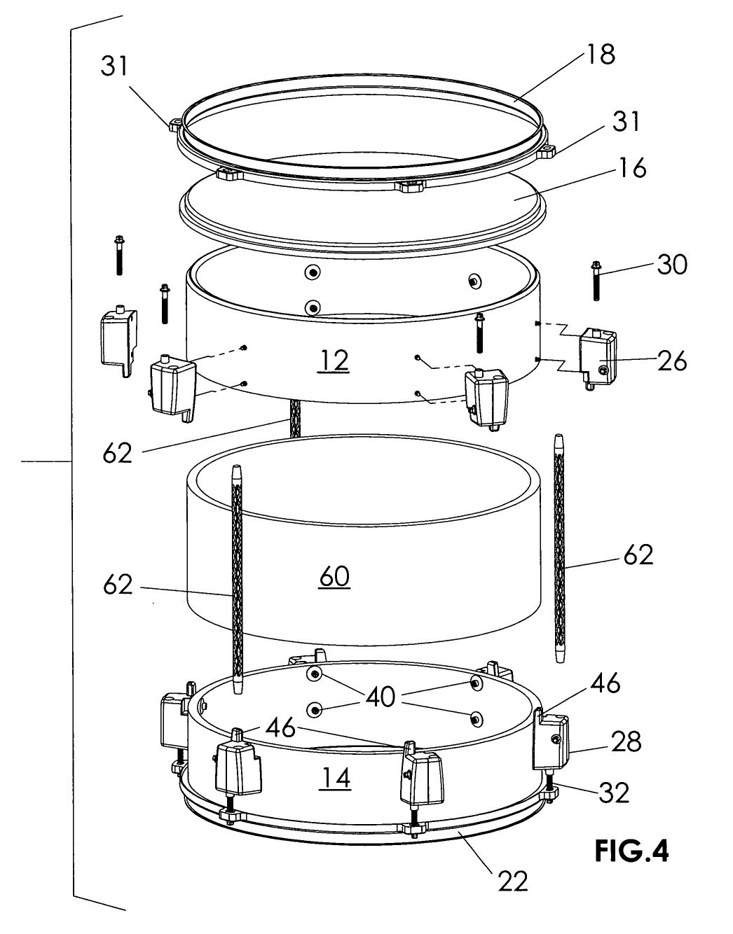

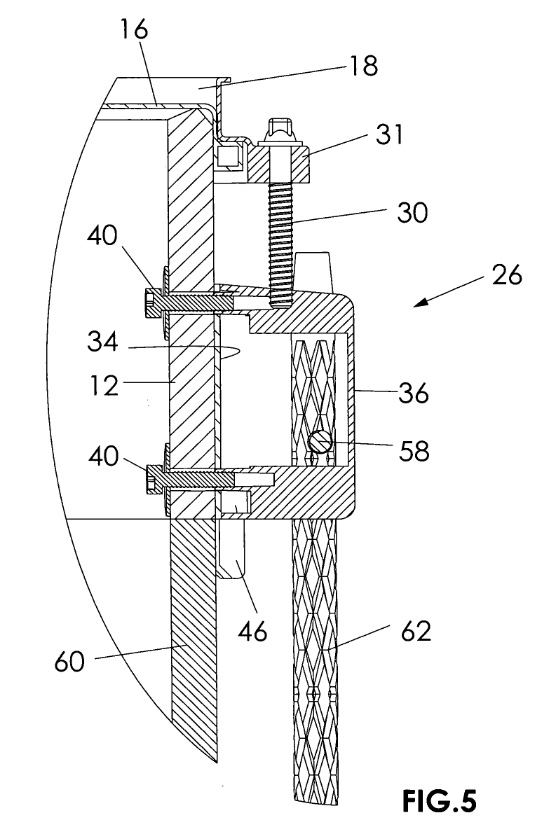

In order to provide a drum having a deeper drum body, one (or more) drum body extensions (60) are provided FIG. 3 and 4. The drum body extension (60) is a cylindrical tubular member, in this case being of the same material as the first drum body member and second drum body member although other materials may be used if desired, and usually having the same wall thickness.

The drum body extension (60) is simply placed between the edges of the first drum body member and the second drum body member, in edge abutting relation.

Longer drum body connector rods(62) are then fitted into the appropriate first tension 20 member and second tension member, and bolts or set screws (58)are torqued firmly to hold the edges of the first drum body member, second drum body member and drum body extension together.

It will be seen that the shell (46) of each of the first tension member and second tension member overlap the adjacent edge of the drum body extension (60).

The shell (46) also overlap the edges of the first and second drum bodies, when in the shorter drum mode of FIG. 1. In this way the drum body extension (60) is held in alignment with the first drum body member and second drum body member.

When the drum body extension is not in use, and the drum (10) is back down to the smaller size as in FIG. 1, the the elongated shell (46) of one tension member will be received in the inward angled indent (42) and cut away wall (48), so that they interdigitate with one another.

A resilient holding plate (64) is supported in slides (66) within the outer box portion (36), having a hole (68) registering with the first tension member or second tension member as the case may be. Plate (64) may be of rubber, or similar synthetic material and functions to hold the socket nuts (54) in position in registration with the tension rod openings (52).

The utility of the invention will be self explanatory from the above.

By the mere addition of the elongated shell (60) and the longer drum body connector rods (62) the drum (10) of FIG. 1 can be changed into the deeper drum of FIG. 3. It can be changed back again in the manner described.

An alternate embodiment can provide a form of extension kit for changing the size of an existing drum. The owner of a drum may wish to extend its depth (or may wish to reduce it). The kit will permit this, given a certain degree of handyman skills on the part of the drum owner.

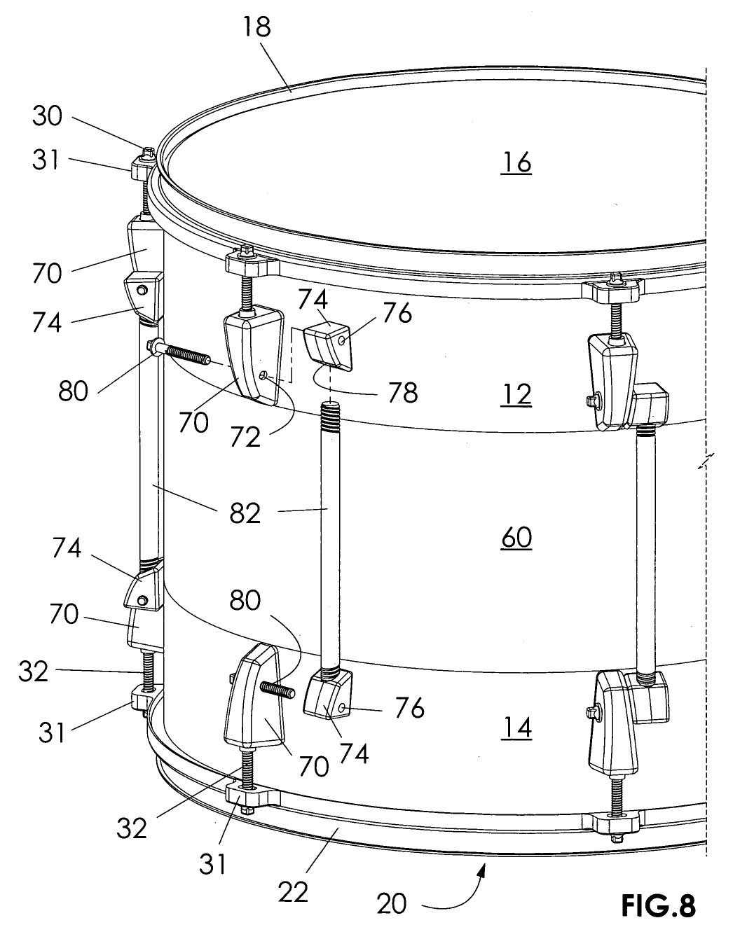

FIG. 8 shows a preexisting drum having upper and lower drum bodies (12) and (14). These drum bodies may have been originally in one piece as a single integral drum body. The owner has simply cut them in to two parts, with a saw. For that reason the two bodies are referenced as (12) and (14). Each of the drum bodies has a skin (16) and (18) and a hoop (20) and (22).

Each of the drum bodies has tension members (70). Such tension members are generally available for construction of conventional drums.

In order to adapt them for use with the extension kit, the tension members are drilled out, transversely as at (72), by the owner.

Connector blocks (74) are provided, which can be attached to respective drum bodies. Transverse holes (74), which may be internally threaded, receive bolts (80) from tension members (70), for attaching the connector blocks to respective drum bodies. Alternatively the blocks could be attached to the drum bodies by bolts (not shown) as in FIG. 6 for example.

Threaded recesses (78) in blocks (74) receive connector rods (82). An extension body (60) can be placed between bodies (12) and (14). The connector rods (82) can be torqued down to grip the body (60) in position.

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. An interchangeable drum assembly comprising;
a first drum body member, having a first drum skin and hoop;
a second drum body member, having second drum skin and hoop;
first tension members on the first drum body for tensioning said first drum skin second tension members on the second drum body for tensioning said second drum skin, and,
drum body connector rods extending between said first and second drum bodies and connected to said some of said first and second tension members whereby the first and second drum bodies are attached to one another in edge abutting relation.

2. An interchangeable drum assembly as claimed in claim 1 including first and second drum skin hoops, and said first tension rods connecting with said first drum skin hoop, and said second tension rods connecting with said second drum skin hoop.

3. An interchangeable drum assembly as claimed in claim 1 wherein said tension rods pass into respective tension members and wherein said drum body connector rods pass into some of said first and second tension members.

4. An interchangeable drum assembly as claimed in claim 3 wherein said drum body connector rods are releasable from said tension members to permit the first drum body and second drum body to be separated from one another.

5. An interchangeable drum assembly as claimed in claim 4 including a drum body extension between the first drum body and the second drum body, and extension drum body connector rods extending between the first tension member and the second tension member holding the first drum body and second drum body and the drum body extension together.

6. An interchangeable drum assembly as claimed in claim 5 wherein the first tension member and the second tension member include extension portions overlapping the drum body extension and holding said drum body extension in alignment with the first drum body and the second drum body.

7. An interchangeable drum assembly as claimed in claim 6 wherein the first tension member and second tension member are secured to their respective first drum body and second drum body by bolts passing from the interior of the first drum body and second drum body into the first tension member and second tension member.

8. An interchangeable drum assembly as claimed in claim 7 wherein the first tension member and the second tension member comprise an inner gasket portion and an outer box portion interfitting with one another and defining a hollow interior chamber, with the bolts passing from the first drum body and second drum body through the inner gasket portion and secured in the outer box portion.

9. An interchangeable drum assembly as claimed in claim 5 wherein said first and second connector rods pass into respective said first and second tension members and including set screws in said first and second tension members operable to engage and hold respective said connector rods.

10. An interchangeable drum assembly as claimed in claim 9 including socket nuts in said first and second tension members registering with holes therein, for reception of respective first and second tension rods within said hollow interior chambers thereof.

11. An interchangeable drum assembly as claimed in claim 10 including a flexible resilient member in each of said first and second tension members, inter engaging with said socket nuts and holding them in registration with their respective holes.

12. An interchangeable drum assembly as claimed in claim 1 including a plurality of connector blocks attachable to respective drum bodies, and connector rods connectable between pairs of said connector blocks.

13. An interchangeable drum assembly as claimed in claim 12 including bolts connectable between said tension members and said connector blocks for attaching said connector blocks to said drum bodies.

14. An interchangeable drum assembly as claimed in claim 13 including transverse holes extending into said connector blocks for receiving said bolts, and holes normal to said transverse holes for receiving said connector rods.
